(19) United States
(12) Patent Application Publication
(10) Pub. No.: US 2013/0050246 A1
(43) Pub. Date: Feb. 28, 2013

(54) METHODS AND APPARATUS TO MONITOR COMPUTING RESOURCES

(71) Applicants: Timothy G. Barry, Fort Collins, CO (US); Philip M. Walker, Fort Collins, CO (US)

(72) Inventors: Timothy G. Barry, Fort Collins, CO (US); Philip M. Walker, Fort Collins, CO (US)

(21) Appl. No.: 13/214,935

(22) Filed: Aug. 22, 2011

(51) Int. Cl. G09G 5/02; G06F 11/30

(52) U.S. Cl. 345/593

(57) ABSTRACT

Methods and apparatus to monitor computing resources are disclosed. An example method to monitor computing resources includes a determination of a first color indicative of a usage of a first computing resource managed by a first virtual machine and a determination of a second color indicative of a usage of a second computing resource managed by the first virtual machine. The example method also includes the first color and the second color being combined to determine a third color and the third color being displayed to indicate an allocation of computing resources managed by the first virtual machine.

### BACKGROUND

Virtual machine managers, also known as hypervisors, are hardware virtualization techniques that allow multiple operating systems to run concurrently on a host computer by managing the execution of the operating systems and the shared computing resources. The consumption of computing resources and the amount of available computing resources within or across hypervisors have typically been represented by numerical quantities or bar charts.

### BRIEF DESCRIPTION OF THE DRAWINGS

FIG. 1 is a block diagram of an example system including an example allocation indicator.

FIG. 2 illustrates an example display of the example system of FIG. 1.

FIG. 3 illustrates another example display of the example system of FIG. 1.

FIG. 4 illustrates yet another example display of the example system of FIG. 1.

FIG. 5 is a flowchart representative of example machine-readable instructions that may be executed to implement the example allocation indicator of FIG. 1.

FIG. 6 is a flowchart representative of further example machine-readable instructions that may be executed to implement the example allocation indicator of FIG. 1.

FIG. 7 is a block diagram of an example computer platform that may execute, for example, the machine-readable instructions of FIGS. 5 and/or 6 to implement the example allocation indicator of FIG. 1.

### DETAILED DESCRIPTION

Many applications or visual displays that provide an indication of consumed and/or available computing resources are directed to numerical quantification and/or elementary bar charts that make it challenging for humans to visualize a current load of one or more hypervisors or the demand that a set of virtual machines will place on one or more hypervisors with varying allocation schemes or planned demand.

Example methods, apparatus and articles of manufacture disclosed herein provide a representational form for virtual machine/hypervisor computing resource relationships that can be used by user interfaces, graphical algorithms and/or image processing algorithms. Examples disclosed herein utilize a color representation such as, for example, the red-green-blue palette or model (RGB), of virtual machine and hypervisor computing resources to assist in manual and/or automated planning, managing, scheduling and/or migrating of virtual machines in, for example, a cloud computing environment. The examples disclosed herein are usable to reconfigure or reallocate the computing resources for improved balance of those resources. Disclosed examples provide an annotation mechanism to aid in the visual and algorithmic representation of computing resource metrics of, for example, central processing unit (CPU), disk space availability (DISK) and memory capacity (MEMORY) with a consistent, canonical representation as an RGB encoded quantity (though other color models/schemes may additionally or alternatively be employed). In some such example(s), CPU resources are designated with a color and intensity of the red component of the RGB model, DISK resources are designated with the color and intensity of the green component, and MEMORY resources are designated with the color and intensity of the blue component. When represented as an RGB quantity or measure, the CPU-DISK-MEMORY representation of a virtual machine and/or hypervisor may be quickly and effectively shared between user interfaces and automated processes for managing cloud resources. For example, where the virtual machines represent nodes of requested CPU-DISK-MEMORY resources and the hypervisors are nodes of available CPU-DISK-MEMORY resources to be scheduled, a manual and/or automated scheduler can manage the computing resources to determine which computing resources are available to satisfy the requests with a quick visual review of the color encoded icons representing the computing resources. In some examples, an automated scheduler uses a processor to review the color components of the encodings.

Example methods disclosed herein include determining a first color indicative of a usage of a first computing resource managed by a first virtual machine and determining a second color indicative of a usage of a second computing resource managed by the first virtual machine. Some such example methods also include combining the first color and the second color to determine a third color, and displaying the third color to indicate an allocation of one or more computing resources managed by the first virtual machine.

Example machine readable mediums storing instructions which, when executed, cause a machine to assign a first color representing a numerical value indicative of a usage of a first computing resource managed by a first virtual machine are described herein. Such instructions cause the machine to assign a second color representing a numerical value indicative of a usage of a second computing resource managed by a first virtual machine. Some such example instructions, when executed, also cause a machine to display an icon having a third color that is an aggregate of the first color and the second color. In such examples, the third color is indicative of an allocation of one or more computing resources.

An example system disclosed herein includes a plurality of virtual machines managing a plurality of computing resources. Some such example systems also include an encoder to assign a first color to a first icon representative of a usage of a first computing resource, to assign a second color to a second icon representative of a usage of a second computing resource, and to assign a third color to a third icon representative of an aggregate usage of the first computing resource and the second computing resource. In some examples, the third color is a combination of the first color and the second color. Some example systems include a display to display the third icon to provide a visual identifier of the allocation of computing resources of the virtual machines.

Example computing resource status displays disclosed herein provide a display of an allocation of computing resources managed by one or more virtual machines and/or hypervisors. In some examples, a level of usage of a computing resource (e.g., CPU, DISK, MEMORY) relative to its capacity is determined Such a usage level is represented as a color. In some examples, each type of computing resource has an associated color (e.g., as noted above, CPU as red, DISK as green and MEMORY as blue). In other examples, colors other than the RGB model may be used alternatively or in addition to the RGB model. For example, the CMYK color model may additionally or alternatively be used. The CMYK color model includes cyan, magenta, yellow, and key (black). In addition, a usage level of a computing resource may correspond to a color intensity. For example, a low MEMORY usage may correspond to a dull blue and a high MEMORY usage may correspond to a bright blue. In some examples, colors of several computing resources are mixed to generate a single color or a joint color that is indicative of an allocation of multiple computing resources managed by a virtual machine. In addition, in some examples, the generated colors are displayed in an array. The colors in an array may be grouped according to a usage condition. For example, colors indicating similar usage may be displayed in a grouped arrangement, as described further below. Other display types including bar codes, x/y grids, pie charts and/or color wheels may additionally or alternatively be used.

There are many advantages of examples disclosed herein. For example, example allocation methods and/or systems disclosed herein do not merely focus on primary allocations of common approaches such as, for example, first-fit, best-fit or worst-fit. In addition, examples disclosed herein do not have to be driven from above (e.g., do not have to be driven through an application programming interface which is driven through a user interface).

Examples disclosed herein enable the visualization of the usage and availability of hypervisor resources in a graphically intuitive way. Further, a proposed virtual machine node and/or hypervisor may be represented and readily manipulated. Also, the hypervisor resource management tools are not limited to those within a single vendor. Rather, different types of hypervisors that may be present in, for example, a cloud computing environment are able to be managed by the examples disclosed herein which enable a single, vendor-neutral approach to represent, visualize and/or manage the computing resources.

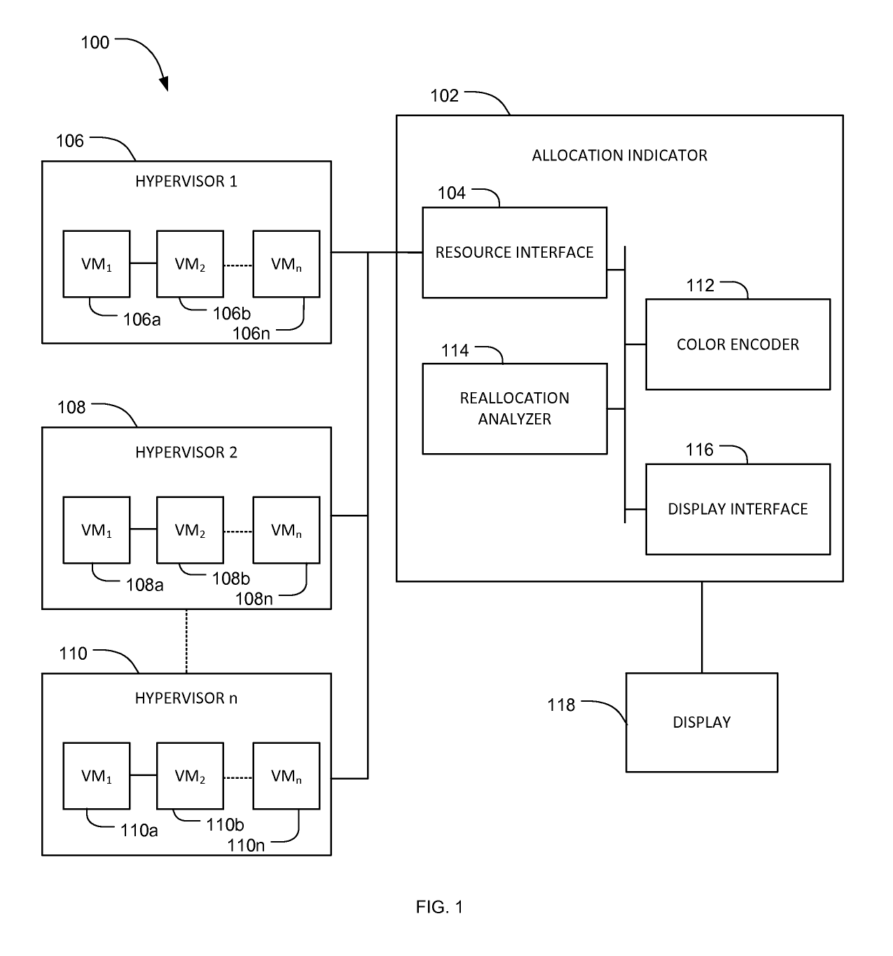

FIG. 1 is a block diagram of an example system 100 including an example computing resource allocation indicator 102. The example allocation indicator 102 of FIG. 1 includes a resource interface 104, which is communicatively coupled to a first hypervisor 106. The first hypervisor 106 manages one or more virtual machines 106a, 106b, 106n. The allocation indicator 102 may also be coupled to a second hypervisor 108 that also manages one or more virtual machines 108a, 108b, 108n. The allocation indicator 102 may be coupled to any number of hypervisors as indicated by the nth hypervisor 110, which manages one or more virtual machines 110a, 110b, 110n. The hypervisors 106, 108, 110 may be the same type of hypervisor, may be different type(s) of hypervisors, and/or may be existing and/or planned hypervisors with existing and/or planned virtual machines resources.

The example allocation indicator 102 of FIG. 1 includes a color encoder 112. The color encoder 112 assigns a color encoding to a virtual machine (e.g., the color encoder 112 encodes an icon representing a virtual machine with a color and/or color intensity based on the usage and/or availability of the computing resources of the virtual machine). The encodings may additionally or alternatively be based on the average, median and/or normal virtual machine resources and resource requests. In addition, the encodings may additionally or alternatively be determined based on average, median and/or normal available hypervisor resources.

The encoding may correspond to a numerical representation. For example, the CPU resource may correspond to an x-bit encoded representation of a product of (processor count) x (frequency) x (cores) and be represented by a red color component. The DISK resource may correspond to a y-bit encoded representation of MB/GB/TB (megabyte, gigabyte, terabyte) of available or requested primary disk space and be represented by a green color component. Additionally or alternatively, the MEMORY resource may correspond to a z-bit encoded representation of MB/GB available or requested main memory space and be represented by a blue color component. The x, y and z component(s) could be normalized or scaled to same reference point(s) of available hypervisor resources and/or of planned/requested virtual machines.

In some examples, the encoder 112 determines an encoding that represents a combination of used and/or available resources. In some such examples, the combination may be a composite or joint color that, as described in greater detail below, is a blend of two or more colors or an assignment of yet another color.

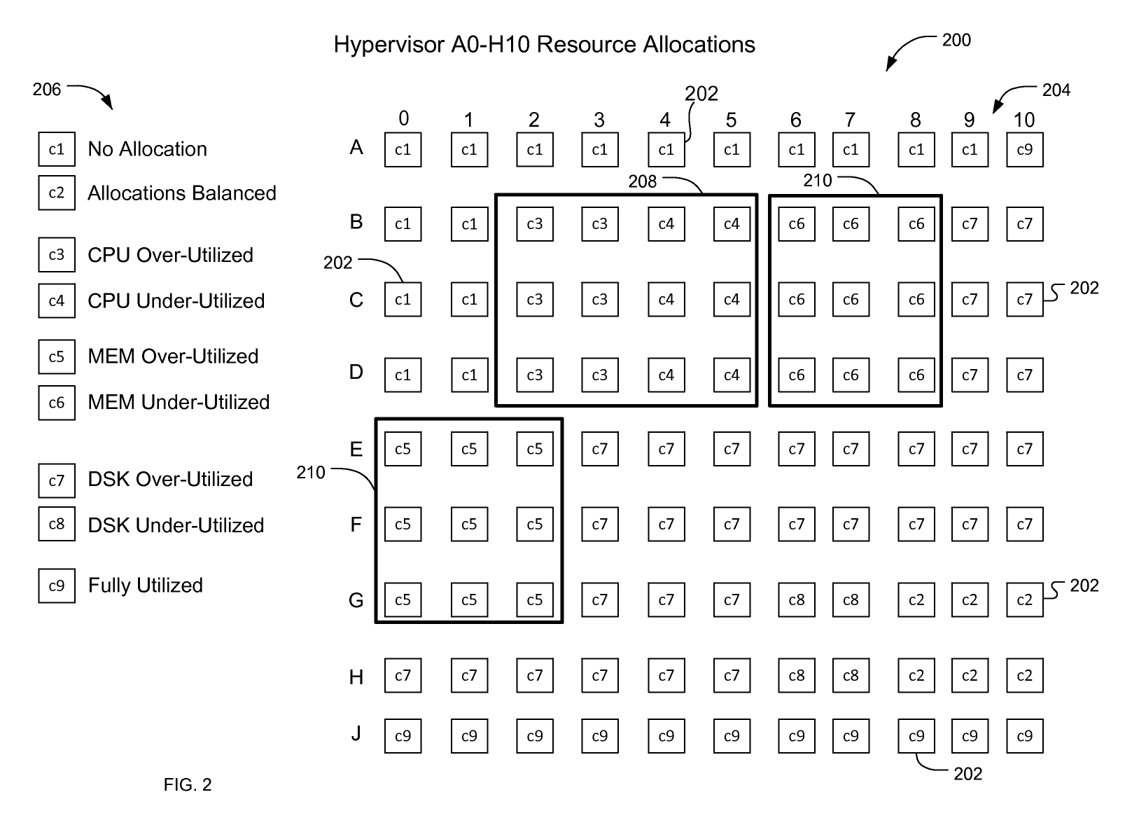

A balancer or reallocation analyzer 114 is also included in the example allocation indicator 102 of FIG. 1. The reallocation analyzer 114 of the illustrated example organizes the icons representing the virtual machines 106a-n, 108a-n, 110a-n. The example reallocation analyzer 114 of FIG. 1 organizes the icons into an array, as shown in FIG. 2 and described in greater detail below. The reallocation analyzer 114 of the illustrated example determines where certain computing resources are under-utilized and where certain resources are over-utilized, and groups the computing resources into complementary pairs. Computing resources may be redistributed or reallocated between the complementary pairs to provide a more balanced distribution of computing resources.

The reallocation analyzer 114 of the illustrated example analyzes the computing resources in a current state, a planned future state and/or a hypothetical state (e.g., under different allocation schemes). The reallocation analyzer 114 of the illustrated example provides one or more reallocation strategies for each situation. In some examples, the reallocation analyzer 114 shows what an allocation of computing resources would be after a reallocation but before any such reallocation actually occurs. Thus, a manager of the cloud or other computing environment (e.g., a resource manager) can determine alternative fitting schemes for the allocated computing resources—or an automated reallocation algorithm may make recommendations for a better fit of the consumed resources versus the available resources. Further, an automated reallocation scheme could present scenarios that minimize the number of shuffles or migrations of virtual machines from one hypervisor to another to optimize these operations.

The example allocation indicator 102 of FIG. 1 also includes a display interface 116 that communicatively couples the allocation indicator 102 to a display device 118. Various types of displays may be generated by the example system 100 of FIG. 1 to enable, for example, a resource manager to utilize color mapping(s) to adjust the allocation and/or balance of current, scheduled and/or hypothetical usage of computing resources of virtual machine(s) and/or hypervisor(s).

While an example manner of implementing the allocation indicator 102 has been illustrated in FIG. 1, one or more of the elements, processes and/or devices illustrated in FIG. 1 may be combined, divided, re-arranged, omitted, eliminated and/or implemented in any other way. Further, the resource interface 104, color encoder 112, reallocation analyzer 114, the display interface 116, and/or more generally the example allocation indicator 102 of FIG. 1 may be implemented by hardware, software, firmware and/or any combination of hardware, software and/or firmware. Thus, for example, any of the example resource interface 104, the color encoder 112, the reallocation analyzer 114, the display interface 116 and/or, more generally, the example allocation indicator 102 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the resource interface 104, the color encoder 112, the reallocation analyzer 114, the display interface 116 and/or the example allocation indicator 102 of FIG. 1 are hereby expressly defined to include a tangible computer-readable medium such as a memory, DVD, CD, etc. storing the software and/or firmware. Further still, the example resource interface 104, the color encoder 112, the reallocation analyzer 114, the display interface 116, and/or the example allocation indicator 102 of FIG. 1 may include one or more elements, processes and/or devices in addition to, or instead of, those illustrated in FIG. 1 and/or may include more than one of any or all of the illustrated elements, processes and devices.

FIG. 2 illustrates an example display 200 that includes a plurality of icons 202 arranged in an array 204. There are ninety-nine icons 202 in the example array 204 of FIG. 2. The icon(s) 202 represents corresponding hypervisors. The icon(s) 202 may be implemented by one or more pixels, a polygon of pixels or any other shape of pixels. There may be any number of icons shown in other example arrays depending on the size, nature and/or complexity of the represented computing environment. In some examples, each icon could represent a virtual machine and/or a computing resource. In the example of FIG. 2, each icon 202 is presented in a color that represents a computing resource allocation state of a corresponding hypervisor. In the example of FIG. 2, nine colors, c1-c9, are used. In other examples other colors, more colors, less colors and/or different intensities of colors may be used. Still further, in some examples, any one of the icons 202 may include multiple colors and/or one or more patterns.

The example display 200 of FIG. 2 includes a legend 206. The legend 206 of the illustrated example indicates the meaning of each color used in the array 204. For example, color cl (e.g., black) indicates that no CPU-DISK-MEMORY resources are allocated to the virtual machine(s) of the associated hypervisor(s). Color c2 (e.g., gray) indicates that the CPU-DISK-MEMORY resources of the virtual machine(s) of the associated hypervisor(s) are partially utilized in a relatively balanced allocation. Color c3 (e.g., red) indicates that the CPU resources of the virtual machine(s) of the associated hypervisor(s) are relatively over-utilized. Color c4 (e.g., cyan) indicates that the CPU resources of the virtual machine(s) of the associated hypervisor(s) are relatively under-utilized. Color c5 (e.g., green) indicates that the MEMORY resources of the virtual machine(s) of the associated hypervisor(s) are relatively over-utilized. Color c6 (e.g., magenta) indicates that the MEMORY resources of the virtual machine(s) of the associated hypervisor(s) are relatively under-utilized. Color c7 (e.g., blue) indicates that the DISK resources of the virtual machine(s) of the associated hypervisor(s) are relatively over-utilized. Color c8 (e.g., yellow) indicates that the DISK resources of the virtual machine(s) of the associated hypervisor(s) are relatively under-utilized. Finally, color c9 (e.g., white) indicates that the 100% of the CPU-DISK-MEMORY resources of the virtual machine(s) of the associated hypervisor(s) are allocated (i.e., that the corresponding hypervisor is fully utilized).

A resource manager can determine where and how to reconfigure or reallocate computing resources to improve the balance of the computing resources by looking at the array and matching colors representing complementary resource statuses in the example display 200 of FIG. 2. For example, colors c3 and c4 can be paired to indicate that the corresponding resources can be moved to balance over-utilized and/or under-utilized CPU resources. Also, colors c5 and c6 can be paired to indicate that the corresponding resources can be moved to balance over-utilized and/or under-utilized MEMORY resources. Colors c7 and c8 can be paired to indicate that the corresponding resources can be moved to balance over-utilized and/or under-utilized DISK resources. Colors cl and c9 can be paired to indicate that the corresponding resources can be moved to balance over-utilized and/or under-utilized hypervisors.

The example display 200 of FIG. 2 includes grouping indicators or designations. A first grouping 208 of hypervisors is shown by a box that surrounds a set of icons 202 representing hypervisors that are candidates for reallocation. The first grouping 208 of hypervisors indicates that Hypervisors B2, B3, C2, C3, D2, and D3 are complementary with Hypervisors B4, B5, C4, C5, D4, and D5. In this example, Hypervisors B2, B3, C2, C3, D2, and D3, which are indicated by icons 202 colored c3, have under-utilized CPU resources. Hypervisors B4, B5, C4, C5, D4, and D5, on the other hand, are indicated by icons 202 colored c4 and have over-utilized CPU resources. Therefore, the system 100 displays grouping 208 to indicate CPU resources may be moved from Hypervisors B2, B3, C2, C3, D2, and D3 to Hypervisors B4, B5, C4, C5, D4, and D5 to improve the balance of computing resources.

FIG. 2 shows a second example grouping indicator 210. The second example grouping indicator 210, is not a contiguous box but rather two separate groupings. Upon review of the example display 200 and the second grouping indicator 210, the resource manager would see that, to better balance MEMORY resource consumption, MEMORY intensive virtual machines could be shifted from the c5 hypervisors (i.e., Hypervisors E0, E1, E2, F0, F1, F2, G0, G1, and/or G2) to the c6 hypervisors (i.e., Hypervisors B6, B7, B8, C6, C7, C8, D6, D7, and/or D8).

The example display 200 of FIG. 2 also provides other information. For example, each row (A-I) may represent a rack. Row A shows that Hypervisors A0-A9 have been powered down (color c1, indicating no allocation). This indicates to the resource manager to move virtual machine(s) off Hypervisor A10 (color c9, indicating fully utilized). The example display 200 of FIG. 2 also indicates that rack I is fully utilized. In addition, the example display 200 of FIG. 2 shows an abundance or excess, in this example, of hypervisors with over-utilized DISK resources (color c7). This indicates that more storage is to be provided for these hypervisors, the price of storage across the remaining hypervisors might be increased, and/or the price of MEMORY and CPU resources across all of the hypervisors might be reduced.

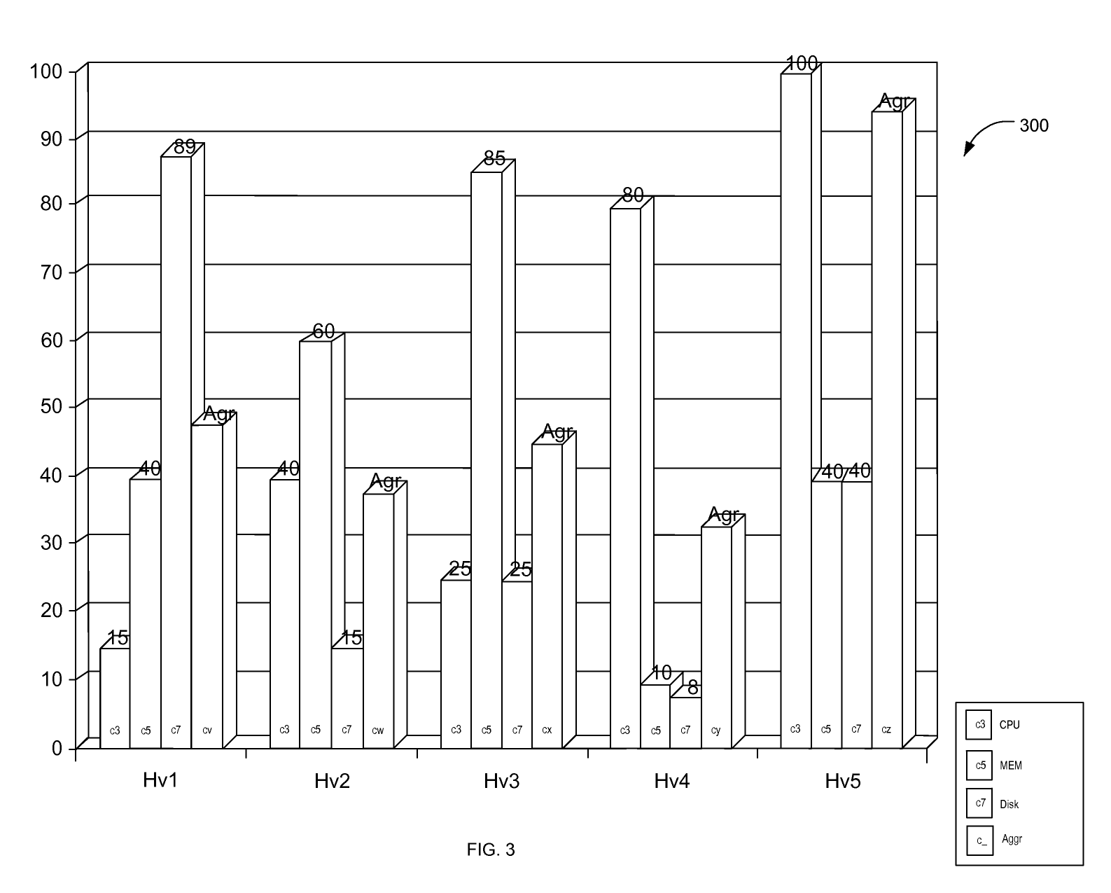

FIG. 3 shows another example display 300. The example display 300 of FIG. 3 shows the use of CPU-DISK-MEMORY resources in relative percentages for five hypervisors, Hv1-Hv5, in groups of icons (here, bars of a bar chart) for each hypervisor. In the example of FIG. 3, instead of the colors representing an over-utilization or an under-utilization of a resource, the colors represent the resources themselves. For example the color c3 (e.g., red) represents the CPU resource, c5 (e.g., green) represents the MEMORY resource and c7 (e.g., blue) represents the DISK resource. The length of the bar corresponds to the relative percentage of use of the corresponding resource as indicated on the y-axis. For example, for Hypervisor Hv1, the CPU is 15% utilized, the MEMORY is 40% utilized and the DISK is at 88% utilized. Various other example utilization levels for the CPU-DISK-MEMORY resources are shown for Hypervisors Hv2-Hv5.

Each set of bar(s) for each hypervisor of the illustrated example includes a fourth bar. The fourth bar of each set is an aggregate, composite or joint color of the allocation status of that particular hypervisor. The joint color may be, for example, a blend of the colors of the CPU-DISK-MEMORY designation, a different color (e.g., not related to the other three colors), an addition of the colors, an average of the RGB values of the colors, or a formulaic merge of the exact percentages of the three colors mapped to a normalized 8-bit color component. The color of the aggregate (e.g., joint color) provides a visual indication of the relative allocations of the corresponding hypervisor. Thus, a visual examination of the display 300 reveals that Hypervisor Hv1 has DISK resources relatively over-allocated, Hypervisor Hv3 has MEMORY resources relatively over-allocated and Hypervisor Hv5 has CPU resources relatively over-allocated.

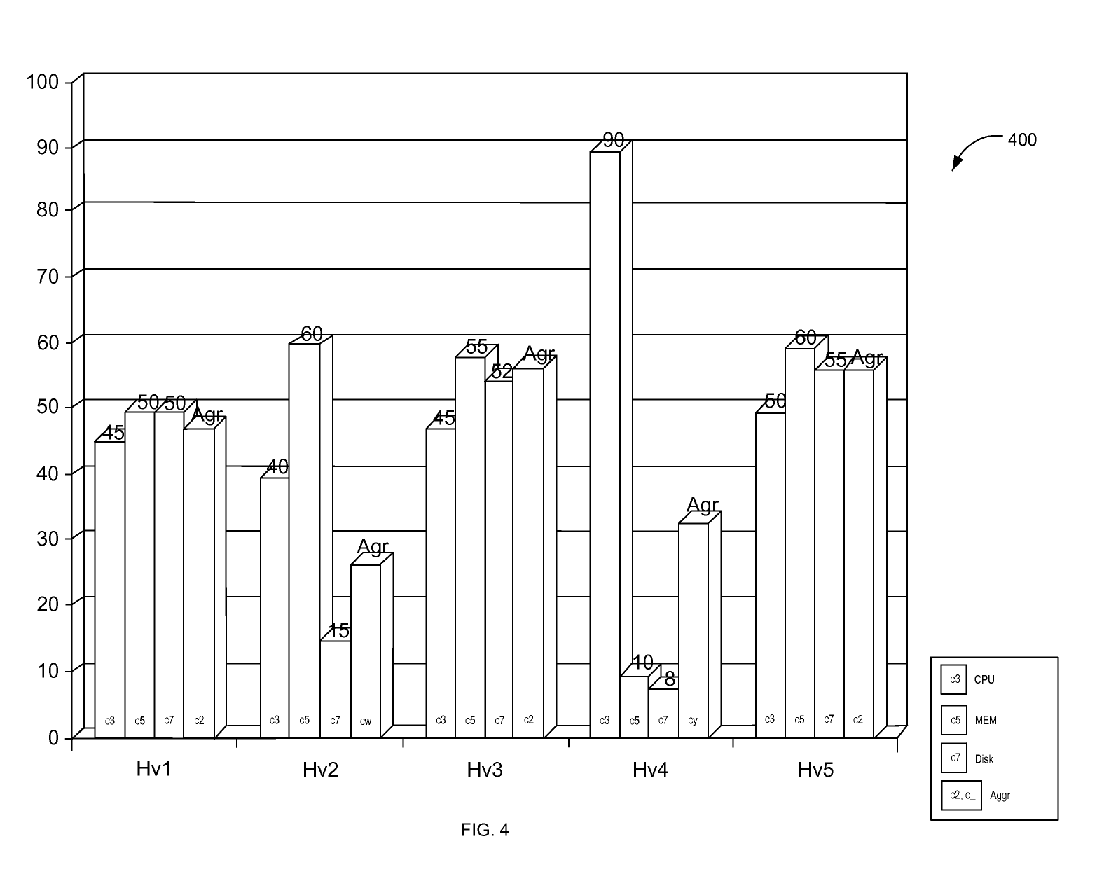

FIG. 4 shows an example display 400 of the relative resource allocation of the five hypervisors of FIG. 3 after a reallocation of computing resources has been planned for Hypervisors Hv1, Hv3 and Hv5. As can be seen in the example of FIG. 4, Hypervisors Hv1-Hv5 continue to host a variety of differently sized virtual machines in terms of the CPU-DISK-MEMORY resources. However, the load against these resources is now more evenly balanced as compared to the state shown in FIG. 3. Hypervisors Hv1, Hv3 and Hv5 now show aggregate bars that are color c2 (e.g., gray), which, as described above, is used in these examples to indicate a balanced allocation resources.

When properly calibrated and formulated the example encodings described herein enable the development of concrete, consistent, visual representations of resource allocations and comparisons amongst virtual machines and hypervisors. These encoding are useful in cloud management user interfaces to aid administrators or resource managers in recognizing obstacles and trends and in planning, managing, scheduling and migrating virtual machines in a cloud of hypervisors. For example, a visual indication that all the hypervisors are all red (e.g., color c3 in FIGS. 3 and 4) reveals that while CPU resources are available, MEMORY and DISK resources are in relatively shorter supply and may be cost effectively ordered and added to these imbalanced hypervisors. Alternatively, processor (CPU) resources in these hypervisors might be offered (e.g., sold), for example, at a discount, because an excess of these CPU resources are available when compared to the available MEMORY and DISK resources. The resource managers may also look at the various color encodings and see, for example, that there is an assortment of red, green and blue hypervisors and determine how to recombine or reallocate the virtual machines of the hypervisors to balance the hypervisors and return them to, for example, a white color, e.g., a neutral or balanced encoding.

In the illustrated example, color encodings are useable by graphic algorithms to aid and/or automate the planning, managing, scheduling and/or migration of virtual machines in a cloud of hypervisors. For example a graphic algorithm analyzing a display including a color wheel, could analyzing the color-wheel angle comparisons (with Pi/2 representing maximal dissimilarity, i.e., prime candidates for reallocation) to develop a reallocation plan. In addition, the example color encodings are useable by image manipulation algorithms to aid and/or automate the planning, managing, scheduling and/or migration of virtual machines in a cloud of hypervisors. For instance, an administrator may select the most balanced hypervisor as the reference for a “white balance” calculation. The other hypervisor resource representations or encodings may be (re)calibrated and compared against the reference hypervisor. Rebalancing or reallocating could proceed manually or automatically.

Furthermore, the color encodings provide a language or communication medium for representing the state(s) of resource(s) between user interfaces and automated tools that manage cloud resources. The color encodings also provide a cross-hypervisor representation of resources in a cloud of virtual machines and hypervisors. In addition, the color encodings may be used to assign, schedule and/or reallocate computing resources in addition or alternatively to other considerations including, for example the availability of access to a particular network, the availability of secondary storage area network (SAN) storage, power utilization, temperature, storage performance, bandwidth, latency, capacity, etc.

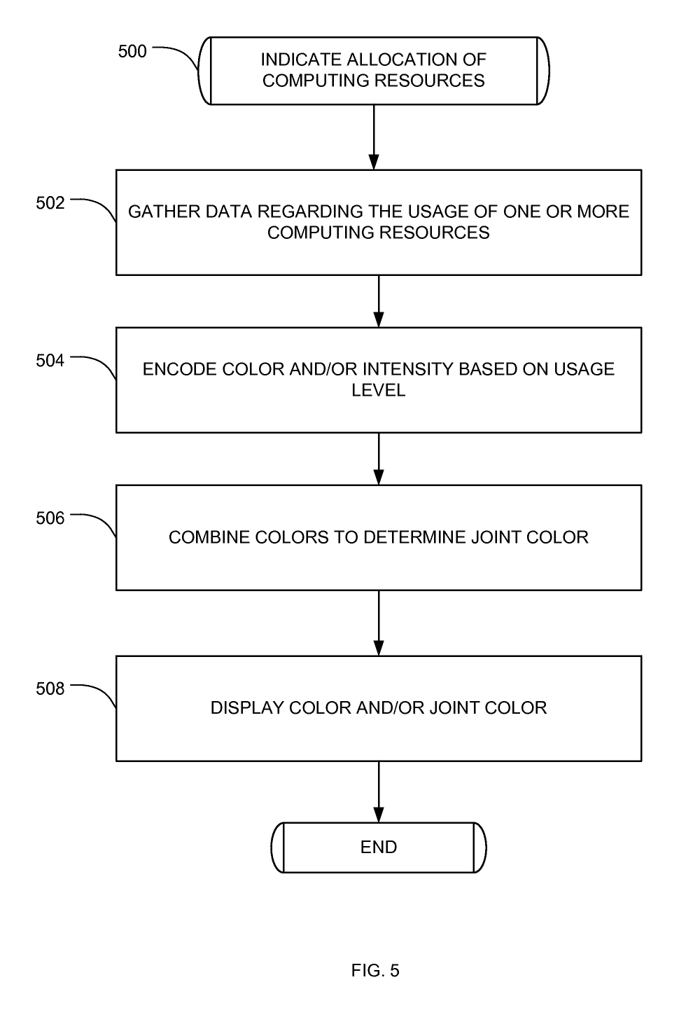

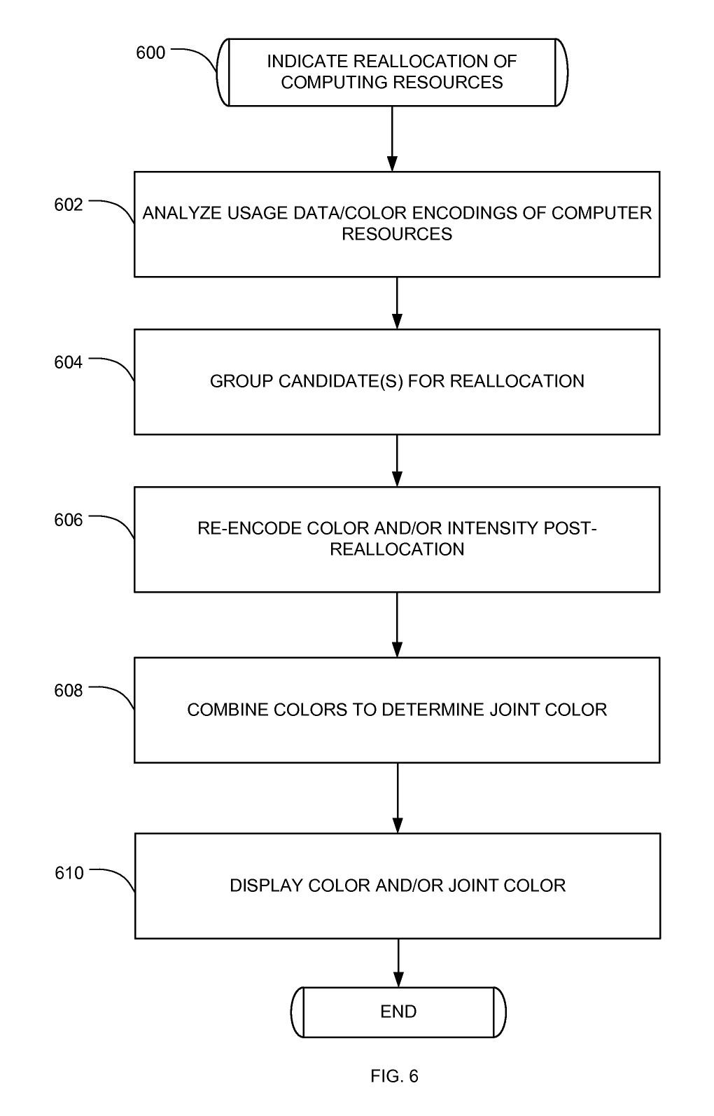

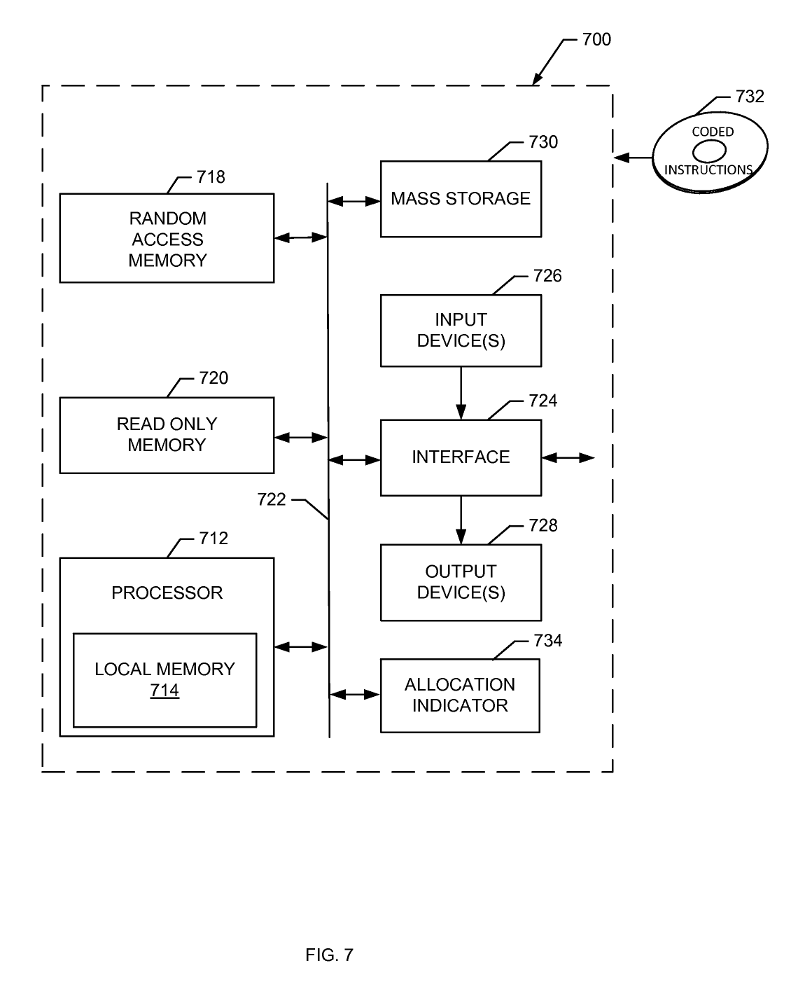

Flowcharts representative of example machine-readable instructions for implementing the example allocation indicator 102 of FIG. 1 are shown in FIGS. 5 and 6. In these examples, the machine-readable instructions comprise a program(s) for execution by a processor(s) such as the processor 712 shown in the example computer 700 discussed below in connection with FIG. 7. The program may be embodied in software stored on a tangible computer-readable medium such as a CD-ROM, a floppy disk, a hard drive, a digital versatile disk (DVD), or a memory associated with the processor 712, but the program and/or parts thereof could alternatively be executed by a device other than the processor 712 and/or embodied in firmware or dedicated hardware. Further, although the example program(s) is described with reference to the flowcharts illustrated in FIGS. 5, and 6, many other methods of implementing the allocation indicator 102 of FIG. 1 may additionally and/or alternatively be used. For example, the order of execution of the blocks may be changed, and/or some of the blocks described may be changed, eliminated, or combined.

As mentioned above, the example processes of FIGS. 5 and/or 6 may be implemented using coded instructions (e.g., computer-readable instructions) stored on a tangible computer-readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer-readable medium is expressly defined to include any type of computer-readable storage and to exclude propagating signals. Additionally or alternatively, the example processes of FIGS. 5, and/or 6 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer-readable medium is expressly defined to include any type of computer-readable medium and to exclude propagating signals.

FIG. 5 is a flowchart representative of example machine-readable instructions 500 that may be executed to implement the example allocation indicator 102 of FIG. 1. FIG. 5 illustrates a process of indicating an allocation of computing resources wherein the allocation indicator 102 gathers data from the hypervisors 106, 108, 110 about the allocation of computing resources, encodes the hypervisors with a color-coded icon 202 and/or color-coded bar graph(s) and generates one or more displays 200, 300, 400.

The process of indicating an allocation of computing resources 500 of FIG. 5, includes gathering data regarding the usage of one or more computing resources (block 502). The computing resources may be, for example, the CPU, MEMORY or DISK resources of a virtual machine, a plurality of virtual machines, a hypervisor managing one or more virtual machines and/or a plurality of hypervisors in a cloud computing environment. The data may be gathered, for example by the example allocation indicator 102 of FIG. 1 via the resource interface 104.

The example process 500 also includes encoding a color and/or an intensity (e.g., of such color) based on the usage level indicated by the gathered data (block 504). The encoding may be executed, for example by the encoder 112 of FIG. 1. The encoder assigns and/or correlates a color (or intensity or pattern or multiple colors, as noted above) to an icon representative of one or more of a computing resource, a virtual machine or a hypervisor. In some examples, the process 500 includes combining the encoding colors to determine a joint color (block 506). The determination of a joint color may be executed by the encoder 112. As noted above, the joint color depicts an aggregate distribution or allocation of the computing resources of one or more of a computing resource, a virtual machine or a hypervisor.

The example process 500 also displays the color and/or the joint color (block 508). For example, the example system 100 of FIG. 1 may display the color encodings as icons 202 as depicted in the example display 200 of FIG. 2 via the display interface 116. The example system 100 may also display the color encodings and the joint color as icons/bar graphs as shown and described above with reference to FIGS. 3 and 4.

FIG. 6 is a flowchart representative of example machine-readable instructions 600 that may be executed to implement the example allocation indicator 102 of FIG. 1. FIG. 6 illustrates a process of indicating an allocation of computing resources wherein the allocation indicator 102 analyzing the color encodings (e.g., FIGS. 2-4), groups candidates for reallocation, and re-encodes the computing resources with a color-coded icon 202/bar graphs and generates one or more displays 200, 300, 400.

The process of indicating a reallocation of computing resources 600 of FIG. 6, includes analyzing usage data/color encodings of the computer resources, virtual machine(s) and/or hypervisor(s) (block 602). This analysis may be performed, for example, with the reallocation analyzer 114 of FIG. 1. The example process 600 includes grouping candidate resources, virtual machine(s) and/or hypervisor(s) for reallocation (block 604). The grouping may also be performed, for example, by the reallocation analyzer 114 of FIG. 1. The identification or grouping of candidates for reallocation may include, for example, the pairing of the encoded icons representing the resources, virtual machine(s) and/or hypervisor(s) with complementary resources, virtual machine(s) and/or hypervisor(s) that have opposite, differing or contrary characteristics. For example, as detailed above, a hypervisor rich in one resource may be paired with a hypervisor that is deficient in that same resource. Two example groupings are shown in FIG. 2 in which candidate hypervisors are boxed together or candidate hypervisors are separately highlighted.

The example process 600 of FIG. 6 also includes re-encoding the color and/or intensity of the icon(s) after the computing resources have been reallocated (block 606) or after a command to ascertain a future or hypothetical reallocation has been received. Block 606 is similar to block 504 of the example process of FIG. 5. The color encoding associated with any given resource, virtual machine and/or hypervisor may be updated based on the addition and/or subtraction of resources from an existing, a planned or a new distribution scheme.

The process of indicating a reallocation 600 also includes combining colors to determine a joint color (block 608), which is analogous to block 506 of FIG. 5, and displaying the color and/or joint color (block 610), which is analogous to block 508 of FIG. 5.

Employing the examples described herein, a resource manager may determine if a virtual machine is a possible fit for a hypervisor by way of a comparison of the virtual machine resource request encodings versus the hypervisor available resource encodings. A resource manager may also determine if a virtual machine is a good fit for a hypervisor based on how the resource color of a hypervisor changes after the virtual machine resources have been subtracted from the resource pool of the hypervisor.

Additionally or alternatively, a resource manager may determine if allocated resources of a hypervisor are out of balance. For example if the color encoding shows one color (e.g., red), then the resource manager would know, via the visual display of the encoded colors, that all or most of the MEMORY and DISK resources are allocated, but CPU resources remain available. Another color (e.g. blue) may indicate to a resource manager that all or most of the DISK and CPU resources are allocated, but MEMORY resources remain available.

Examples disclosed herein also enable a resource manager to determine if a particular allocation scheme allocates planned virtual machines against available hypervisors in a balanced way. For example, if a first-fit results in a display with green, blue and red hypervisors, then maybe another fit (e.g., a better fit) would result in a display with a better color balanced set. A resource manager will be able to spot balance and imbalance across hypervisors, as quickly as the human eye can recognize color differences.

Additionally or alternatively, the outcome of differing sets of allocation schemes may be checked apriori, in real time and/or against each other for how and which allocation schemes will create a balanced result of resource usage against a set of hypervisors with a set of planned virtual machines.

FIG. 7 is a block diagram of an example computer platform 700 capable of executing the instructions of FIGS. 5 and/or 6 to implement the example allocation indicator 102 of FIG. 1. The computer platform 700 can be, for example, a server, a personal computer, a mobile phone (e.g., a cell phone), an Internet appliance, or any other type of computing device.

The system 700 of the instant example includes a processor 712. For example, the processor 712 can be implemented by one or more Intel® microprocessors from the Pentium® family, the Itanium® family or the XScale® family. Of course, other processors from other families are also appropriate.

The processor 712 is in communication with a main memory 714, including a volatile memory 718 and a non-volatile memory 720 via a bus 722. The volatile memory 718 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 718 may be implemented by flash memory and/or any other desired type of memory device. Access to the main memory 714, 718, and/or 720 is typically controlled by a memory controller (not shown).

The computer platform 700 also includes an interface circuit 724. The interface circuit 724 may be implemented by any type of interface standard, such as an Ethernet interface, a universal serial bus (USB), and/or a PCI express interface.

One or more input devices 726 are connected to the interface circuit 724. The input device(s) 726 permit a user to enter data and commands into the processor 712. The input device(s) can be implemented by, for example, a keyboard, a mouse, a touchscreen, a track-pad, a trackball, isopoint and/or a voice recognition system.

One or more output devices 728 are also connected to the interface circuit 724. The output devices 728 can be implemented, for example, by display devices (e.g., a liquid crystal display, a cathode ray tube display (CRT), a printer and/or speakers). The interface circuit 724, thus, typically includes a graphics driver card.

The interface circuit 724 also includes a communication device (e.g., the database communicator 230, the database communicator 320, etc.) such as a modem or network interface card to facilitate exchange of data with external computers via a network (e.g., an Ethernet connection, a digital subscriber line (DSL), a telephone line, coaxial cable, a cellular telephone system, etc.).

The computer platform 700 also includes one or more mass storage devices 730 for storing software and data. Examples of such mass storage devices 730 include floppy disk drives, hard drive disks, compact disk drives and digital versatile disk (DVD) drives. The mass storage device 730 may implement the database 120, the data store 215, and/or the template store 315.

In the illustrated example, the computer platform 700 also includes an allocation indicator 734 such as, for example the allocation indicator 102 of FIG. 1. The allocation indicator 734 of the illustrated example is in communication with the processor 712 and/or the memory (e.g., the main memory 714, the volatile memory 718, and/or the non-volatile memory 720, the mass storage 730, etc.) via the bus 722. In some examples, the allocation indicator 734 is implemented by a processor. In the illustrated example, once computing resource usage and availability data is gathered, the allocation indicator 734 outputs a color encoding displaying how the computing resources in a computing environment are allocated.

The coded instructions of FIGS. 5 and 6 may be stored in the mass storage device 730, in the volatile memory 718, in the non-volatile memory 720, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to monitor computing resources comprising:
determining a first color indicative of a usage of a first computing resource managed by a first virtual machine;
determining a second color indicative of a usage of a second computing resource managed by the first virtual machine;
combining the first color and the second color to determine a third color; and
displaying the third color to indicate an allocation of computing resources managed by the first virtual machine.

2. A method as defined in claim 1, wherein the first color, the second color and the third color are colors in the red-green-blue palette.

3. A method as defined in claim 1, wherein the allocation of computing resources is an indication of a level of usage of at least one resource relative to a capacity of the at least one resource.

4. A method as defined in claim 3, wherein the level of usage of at least one resource is indicated by an intensity of the color.

5. A method as defined in claim 1 further comprising displaying the first, second and third colors in an array and grouping the first, second and third colors in accordance with a usage condition.

6. A method as defined in claim 1 further comprising reallocating a resource and reassigning a color encoding after the reallocation.

7. A method as defined in claim 1 wherein the computer resources include one or more of the central processor, the primary disk or the main memory.

8. A tangible machine readable medium storing instructions which, when executed, cause a machine to at least:
assign a first color to represent a numerical value indicative of a usage of a first computing resource managed by a first virtual machine;
assign a second color to represent a numerical value indicative of a usage of a second computing resource managed by a first virtual machine; and
display an icon having a third color that is an aggregate of the first color and the second color, the third color indicative of an allocation of the first and the second computing resources.

9. A machine readable medium as described in claim 8, further comprising instructions which, when executed, cause a machine to:
assign a fourth color to represent a numerical value indicative of a usage of a third computing resource managed by a second virtual machine;
assign a fifth color to represent a numerical value indicative of a usage of a fourth computing resource managed by a second virtual machine; and
display a second icon having a sixth color that is an aggregate of the fourth color and the fifth color, the sixth color indicative of an allocation of the third and the fourth computing resources.

10. A machine readable medium as described in claim 9, further comprising instructions which, when executed, cause a machine to group the first and the second icons to designate virtual machines that may be candidates for computing resource allocation to balance computing resources.

11. A system to monitor a plurality of virtual machines corresponding to a plurality of computing resources, the system comprising:
an encoder to assign a first color to a first icon representative of a usage of a first computing resource, to assign a second color to a second icon representative of a usage of a second computing resource, and to assign a third color to a third icon representative of an aggregate usage of the first computing resource and the second computing resource, the third color being a combination of the first color and the second color; and
a display to display the third icon to provide a visual identifier of the allocation of the first and the second computing resources of the virtual machines.

12. A system as defined in claim 11, wherein the first color is different from the second color.

13. A system as defined in claim 11, wherein the encoder is to assign a fourth color to a fourth icon representative of a usage of a third computing resource, to assign a fifth color to a fifth icon representative of a usage of a fourth computing resource, and to assign a sixth color to a sixth icon representative of an aggregate usage of the third computing resource and the fourth computing resource, the sixth color being a combination of the fourth color and the fifth color.

14. A system as defined in claim 13, wherein the display is to display the sixth icon.

15. A system as defined in claim 14 further comprising a balancer to determine if a computing resource allocation scheme balances the computing resources and to group the candidate computing resources for reallocation, the display to show the groupings of icons associated with the candidate computing resources.
